(19) United States
(12) Patent Application Publication
(10) Pub. No.: US 2006/0210104 A1
(43) Pub. Date: Sep. 21, 2006

(54) Remote magnetic activation of hearing devices

(75) Inventors: Adnan Shennib, Fremont, CA (US); Ian Day, Fremont, CA (US); John Sadler, Belmont, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: InSound Medical, Inc., Newark, CA (US)

(21) Appl. No.: 11/368,327

(22) Filed: Mar. 2, 2006

Related U.S. Application Data
(63) Continuation-in-part of application No. 09/181,533, filed on Oct. 28, 1998, now Pat. No. 7,016,511.

(51) Int. Cl. H04R 25/00

(52) U.S. Cl. 381/315; 381/328

(57) ABSTRACT

An embodiment provides a user interface for remotely controlling the operational state of a hearing device positioned in the ear canal. The interface comprises a controller, a switch coupled to the controller and an audio port coupled to the controller. The controller switches between the operational states of a hearing device having at least a first and a second operational state, such as an off-state, an on-state. The switch receives inputs from the user to change the operational state of the hearing device and is actuable by an external magnetic field source held in the hand of the user within a selected proximity envelope from the switch. The controller switches between the states responsive to a pattern of movement of the magnetic field source made relative to the proximity envelope. The audio port produces an audio output indicating to the user the operational state of the hearing device.

### CROSS-REFERENCES TO RELATED APPLICATIONS

This application is a continuation-in-part of U.S. patent application Ser. No. 09/181,533 (Attorney Docket No. 022176-000300US), filed on Oct. 28, 1998, the full disclosure of which is incorporated herein by reference.

### BACKGROUND OF THE INVENTION

### Field of the Invention

Embodiments of invention relate to hearing devices. More specifically embodiments of the invention relate to apparatus, systems and methods for remotely controlling the operational state of a hearing aid.

Since many hearing aid devices are adapted to be fit into the ear canal, a brief description of the anatomy of the ear canal will now be presented for purposes of illustration. While, the shape and structure, or morphology, of the ear canal can vary from person to person, certain characteristics are common to all individuals. Referring now to FIGS. 1A-1B. the external acoustic meatus (ear canal) is generally narrow and contoured as shown in the coronal view in FIG. 1. The ear canal 10 is approximately 25 mm in length from the canal aperture 17 to the center of the tympanic membrane 18 (eardrum). The lateral part (away from the tympanic membrane) of the ear canal, a cartilaginous region 11, is relatively soft due to the underlying cartilaginous tissue. The cartilaginous region 11 of the ear canal 10 deforms and moves in response to the mandibular (jaw) motions, which occur during talking, yawning, eating, etc. The medial (towards the tympanic membrane) part, a bony region 13 proximal to the tympanic membrane, is rigid due to the underlying bony tissue. The skin 14 in the bony region 13 is thin (relative to the skin 16 in the cartilaginous region) and is more sensitive to touch or pressure. There is a characteristic bend 15 that roughly occurs at the bony-cartilaginous junction 19 (referred to herein as the bony junction), which separates the cartilaginous 11 and the bony 13 regions. The magnitude of this bend varies among individuals.

A cross-sectional view of the typical ear canal 10 (FIG. 2) reveals generally an oval shape and pointed inferiorly (lower side). The long diameter (D_{L}) is along the vertical axis and the short diameter (D_{S}) is along the horizontal axis. These dimensions vary among individuals.

Hair 5 and debris 4 in the ear canal are primarily present in the cartilaginous region 11. Physiologic debris includes cerumen (earwax), sweat, decayed hair, and oils produced by the various glands underneath the skin in the cartilaginous region. Non-physiologic debris consists primarily of environmental particles that enter the ear canal. Canal debris is naturally extruded to the outside of the ear by the process of lateral epithelial cell migration (see e.g., Ballachanda, The Human Ear Canal, Singular Publishing, 1995, pp. 195). There is no cerumen production or hair in the bony part of the ear canal.

The ear canal 10 terminates medially with the tympanic membrane 18. Laterally and external to the ear canal is the concha cavity 2 and the auricle 3, both also cartilaginous. The junction between the concha cavity 2 and the cartilaginous part 11 of the ear canal at the aperture 17 is also defined by a characteristic bend 12 known as the first bend of the ear canal.

Conventional hearing aids are typically equipped with one or more manually operated switches, such as an ON/OFF switch for activating or deactivating the device, or a control switch for adjusting the loudness or frequency response of the device. Improvements are continuously being made in the miniaturization of these controls in order to produce the smallest possible hearing device. Hearing devices are presently available, for example, that are sufficiently small to fit partially in the ear canal (In-The-Canal, or “ITC” devices) or entirely within the canal (Completely-In-the-Canal, or “CIC” devices), collectively referred to herein as “canal devices”.

Conventional switches used in hearing devices are electromechanical, with electrical settings that are dependent on mechanical position or movement of the switch. For example, U.S. Pat. No. 4,803,458 to Trine et al. discloses a hearing aid miniature switch which is integrated with a potentiometer. Hearing aid switches of the prior art, however, present several problems to manufacturers and users of canal devices. Among the most serious problems presented to manufacturers, for example, is the difficulty of providing designs that allow sufficient space within the hearing device to incorporate a conventional switch along with other key components including the battery necessary to power the device. This problem is particularly frustrating for devices designed to be worn in small or narrow ear canals, but is manageable for the larger hearing devices such as Behind-The-Ear (“BTE”) and In-The-Ear (“ITE”) types. Therefore, conventional switches are usually limited to these larger hearing devices. Additionally, conventional switches are prone to malfunction and frequent repair because of the susceptibility of their mechanical parts to failure (see, for example, Valente, M., “Hearing Aids: Standards, Options, and Limitations”, Thieme Medical Publishers, 1996, p. 239, hereinafter referred to as “Valente”).

Among the problems presented to users of heretofore available canal devices are the inaccessibility of and difficulty to manipulate conventional switches, particularly for the geriatric population, which makes remote controlled hearing devices more suited to such users (Valente, p. 240).

Prior art remote control designs for hearing devices typically employ sound, ultrasonic, radio frequency (RF) or infrared (IR) signals for transmission to the device, examples of which are found in U.S. Pat. Nos. 4,845,755 to Busch et al., 4,957,432 to T. Pholm, 5,303,306 to Brillhart et al., and 4,918,736 to Bordewijk. Such designs typically require additional circuitry to decode the transmitted signal and provide control signals for its internal use, which mandates a need for additional space and power consumption in the device. Availability of space and power, however, are extremely limited in canal devices. Furthermore, operation of buttons or switches typically provided on the remote control unit can present a daunting challenge to users with poor manual dexterity.

Remote control applications which employ reed switches activated by a magnetic field from a proximal magnet are well known, as typified by U.S. Pat. Nos. 3,967,224 to Seeley; 5,128,641, 5,233,322 and 5,293,523 to Posey; and 5,796,254 to Andrus. These patent disclosures describe various configurations of reed switches which are activated by a control magnetic material either a permanent magnet or a magnetically permeably material when placed in proximity to the controlled device. In general, these prior art reed switch remote control designs lack a latching mechanism, and therefore require the continued proximity of the control magnetic material to activate the controlled device. The switch reverts to its normal position immediately upon removal of the control magnetic material from the proximity area.

In prior art hearing aid applications employing a remotely activated reed switch, the switch is typically employed to trigger an input signal for a control circuit within the hearing device. For example, U.S. Pat. Nos. 5,359,321 to Rubic and 5,553,152 and 5,659,621 to Newton disclose reed switches activated remotely by a magnetic field introduced from a hand-held magnet. The reed switches of these prior art disclosures are connected to semiconductor logic or control circuitry and thus indirectly control or switch the parameters of the hearing device. It is well known in the art of semiconductors and circuit design that semiconductor switches can be bulky and require additional control circuitry.

A miniature latching reed switch is ideal for canal devices because no power or control circuitry is required to maintain a particular state. For example, a reed switch can be used to turn off a hearing device by opening the battery circuit, and the off state is then maintained by the switch without consuming any energy from the battery. This is extremely important in long term device applications whereby battery longevity must be maximized.

A latching magnetic reed switch with two modes (positions) is disclosed in U.S. Pat. No. 4,039,985 to Schlesinger, but the switch requires two latching magnets, one for each switch position. A more efficient latching type reed switch shown in FIGS. 2A and 2B manufactured by Hermetic Switch Inc. (model HSR-003DT), has a single magnet bar M mounted externally and perpendicular to the hermetically sealed tubular reed switch R. The ferromagnetic reeds A and B are attached to ferromagnetic lead wires LA and LB. Because the latching magnet M is relatively large, the switch assembly (SA) is roughly twice the size of the reed switch R alone. The magnet may be made somewhat smaller by the selection of magnet material with higher intrinsic magnetic energy, but the air-gap (AG) between magnet M and either of the reeds (A and B) dictates the need for a substantial magnet size to produce the required latching force.

For canal hearing devices, the prior art latching reed switches referred to above are impractical due to size and configuration considerations. As illustrated in FIG. 3, the human ear canal cavity 30 is generally narrow and elongate. Conventional non-latching miniature reed switches (R) are also narrow and elongate making them ideal for concentric longitudinal placement within the ear canal as shown, but the prior art methods of incorporating one or more reed switches R and latching magnets M (shown with dotted perimeter) mandate a prohibitively large switch assembly (SA), as indicated in FIG. 3. The significance of this size limitation is best understood when considering the need to incorporate other critical components (not shown) within a canal hearing device 70, such as a battery, microphone, amplifier circuitry, speaker, and so forth.

### BRIEF SUMMARY OF THE INVENTION

Various embodiments of the invention provide apparatus, systems and methods for the remote control of the operational state of hearing devices such as an ITC or CIC hearing aids. These devices can include extended wear hearing aids configured to be positioned deeply in the ear canal including the bony portion of the canal.

One embodiment provides a magnetic switch assembly for a hearing device adapted for remote activation by the user. The magnetic switch assembly is desirably highly miniaturized with a self-contained latching mechanism. User activation is performed by placing a hand-held magnet in proximity to the hearing device. Use of a magnetically latchable switch allows for remote vs. manual activation of the switch by a hand held magnet.

A variety of miniature magnetic switches can be used. In a preferred embodiment, the switch assembly comprises a miniature reed switch and a miniature latching magnet affixed directly to one of the reeds or to an electrical lead wire associated with a reed. Direct attachment eliminates air gaps between the latching magnet and a reed, thus enabling latching with an extremely small magnet. The magnet, with its ultra-small size, increases the dimensions of the switch assembly by only a negligible amount. The miniature reed switch assembly is desirably configured to minimally impact the overall size and shape of the associated hearing device.

In the “open” position of the switch assembly, in the absence of an external magnetic field (i.e., unaided), the latching magnet generates a weak attraction force by virtue of its limited magnetic field strength which is insufficient to overcome the air gap between the reeds themselves, i.e., to pull together and close the contacts of the two reeds. However, with the application of an external “on” magnetic field (i.e., suitable proximity, polarity and field strength) from an external control magnet wielded by the wearer (i.e., the user) and placed close to the hearing device, the attraction force becomes sufficient to close the contacts. After assuming a “closed” position, the reed contacts remain closed (latched) under the influence of the latching magnet, even after the removal of the external control magnet. Similarly, the switch contacts can be latchably opened by the application of an external “off’ magnetic field from an external control magnet sufficient to overcome the latching force of the latching magnet. Preferably, the control magnet is a hand-held bar or rod with opposite magnetic polarities at its ends, for switching according to the polarity of the end placed proximate to the hearing device. However other shapes and configurations of the control magnet can be employed.

In a preferred embodiment, the latching magnet is placed directly on a ferromagnetic lead wire associated with a first reed of a tubular reed switch positioned horizontally in the ear canal. A second ferromagnetic lead wire, associated with a second reed, is positioned laterally to face an activating magnet placed in close proximity to the aperture of the ear canal by the wearer.

Another embodiment provides a user interface for remotely controlling the operational state of a hearing device positioned in the ear canal of a user. The interface comprises a controller, a switch coupled to the controller and an audio port coupled to the controller. The controller is configured to switch between the operational states of a hearing aid having at least a first and a second operational state, such as an off-state, an on-state. The switch receives inputs from the user to change the operational state of the hearing aid, for example from an off-state to an on-state. The switch is actuable by an external magnetic field source held in the hand of the user within a selected proximity envelope from the switch. The controller is configured to switch between the states responsive to a user pattern of movement of the magnetic field source made relative to the proximity envelope. The audio port is configured to produce an audio output indicating to the user the operational state of the hearing aid. The interface can be calibrated or otherwise adjusted for the specific magnetic field source, hearing device and user anatomy. A related embodiment provides a system comprising a hearing aid with the interface and a hand held magnetic field source.

The controller will typically comprise a state device such as an analog circuit or microprocessor which can include one or more programs or modules such as a state switching module that controls one or more aspects of the state switching process. The audio port will typically comprise a part of the hearing aid such as the audio port of a hearing aid receiver module but can also comprise a separate port coupled to the hearing aid. The magnetic field source can include a handheld magnetic bar, rod or other magnetic actuation member or device which can be attached to a key chain for carrying convenience. One or both ends/poles of the magnetic member can be configured as actuating ends that are brought into the proximity envelope. In many embodiments, the ends are configured to brought into proximity of the outer ear and/or outer ear canal. The ends can also include guards to prevent insertion into the ear canal itself. The switch can include any magnetically actuated switch such as a micro-switch, a miniature magnetic reed switch or the like. The switch can be mounted or otherwise integrated into circuitry used by the hearing aid. The proximity envelope to actuate the switch will typically by bounded by an external portion of the ear canal but can be any selected distance, for example one to five centimeters from the switch. The proximity distance for switch actuation can be fixed or can be programmable either at the factory or by the audiologist or the user. The distance can also be calibrated for a given magnetic member. The movement pattern can include various patterns such as moving the magnetic member into the proximity envelope, moving the member out of the envelope or maintaining the member within the envelope for as selected time period. Combinations of these patterns can in turn, comprise other patterns. For example, two or more of the above patterns can be made in succession, such as moving the magnetic member into the proximity envelope and then moving the member out of the proximity envelope. The patterns can be preset at the factory or can be selectable by the user. The user can also program in custom patterns, for example using the switching module. After a switch between states, the controller can generate a signal sent to the audio port generate an audio output to indicate to the user the device has switched to a new state, as well as indicate what that state is. Typically, the outputs will include one or more beeps, for example a first beep when the device has switched to a first state and two beeps when the device has switched to a second state. The outputs can also include a short beep to indicate that the device has switched states and longer beeps to indicates what the state is. The outputs can also vary in frequency and volume and can also include multiple tone sounds such as a two-tone beep. Similar to the movements patterns, the audio outputs can be preset, selectable, and/or custom programmed.

Typically, the operational states of the hearing aid will include at least an off-state and on-state. In many embodiments, the hearing aid will include three or more states, the additional states including a standby state or low power states. The additional states can also include on-states having varying gains or volumes, for example a first on-state having a first gain and a second. In this way, the user can use the interface to readily change the gain of the hearing aid. Using a similar approach, other operational parameters of the hearing aid can be changed such as the gain profile over a range of frequencies, noise suppression, background filtering parameters and the like. After each gain is selected, the controller can generate a distinct output or beep to let the user know of the gain selection. In one embodiment, the beeps can change in volume in a similar manner that the gain does (e.g., increase or decrease) to provide the user with easily discernable indication of the newly selected gain without the user having to know which particular audio output corresponds to which gain.

Another embodiment of the invention provides a method for remotely controlling the operational the state of a hearing aid positioned in the ear canal. The method comprises positioning a hearing aid in the ear canal of a user. The hearing aid can be positioned anywhere in the canal including in the bony portion of the canal. Positioning can be done by an audiologist or the user. Preferably, the hearing aid has at least a first state and a second state, a magnetically activated switch; and a controller for controlling switching between the states. After positioning, the user can signal a user input to change the state of the hearing aid using a hand held magnetic field source such as a magnetic rod or other hand held magnetic device. Signaling is done through a pattern of movement of the magnetic rod relative to a proximity distance to the switch sufficient to produce a field strength to activate the switch. The pattern of movement can include moving the magnetic rod into proximity, out of proximity or maintaining it within the proximity distance. The pattern of movement can also be selected and even programmed by the user. The proximity distance can comprise a proximity envelope bounding the outside of the external ear canal (or other feature of the ear or head) so that the pattern of movement can comprise moving the magnet rod to relative to the outside of the ear canal.

After a user input is made, the controller is used to switch between the first-state and the second state responsive to the pattern of movement. Subsequent user inputs can be used to change the hearing aid to a third state or even a fourth of fifth state. The user input can be used to change hearing from an off-state to an on-state as well as to change a hearing aid parameter such as gain. Also, an audio output can be generated by the hearing aid to indicate to the user of the change of state as well as the particular state of the hearing aid. These and other embodiments of the invention are described in further detail below.

### BRIEF DESCRIPTION OF THE DRAWINGS

FIG. 1A is a side coronal view of the external ear canal.

FIG. 1B is a cross-sectional view of the ear canal in the cartilaginous region.

FIG. 2A is a fragmentary side view of a latching reed switch assembly of the prior art, discussed above, in which a latching magnet is positioned along the length of the reed switch with an air-gap there between.

FIG. 2B is a cross-sectional view of the latching reed switch assembly of FIG. 1, discussed above.

FIG. 3 is a transparent partial side view of a prior art reed switch assembly in a canal hearing device, discussed above, positioned within a human ear canal.

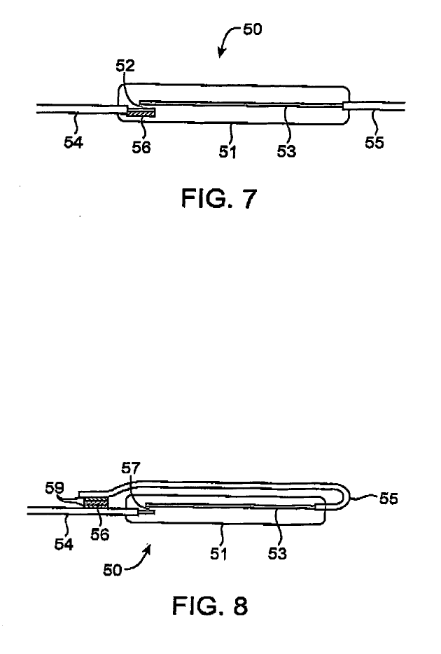

FIG. 4 is a side view of a preferred embodiment of a switch of the present invention, in the open position showing a latching magnet externally positioned and directly on the ferromagnetic lead wire.

FIG. 5 is a side view of the switch embodiment of FIG. 4 in the closed position, showing the control magnet in proximity to the switch.

FIG. 6 is a side view of the switch embodiment of FIG. 4 in the open position, showing magnetic flux lines within the reed switch and from a control magnet placed in proximity thereto.

FIG. 7 is a side view of an alternative embodiment of the reed switch of the invention, with latching magnet internal to the casing and directly affixed to one of the reeds.

FIG. 8 is a side view of another embodiment of the reed switch, in which a magnet is adhesively wedged between the two lead wires of the reeds of the switch.

FIG. 9 is a schematic representation of the latching reed switch assembly of the invention, used as a power switch (ON/OFF) in a hearing device.

FIG. 10 is a schematic representation of the latching reed switch assembly of the invention, used as a volume control switch in a hearing device.

FIG. 11 is a side view of a dual switch configuration showing individual switch action according to the proximity of a control magnet.

FIG. 12 is a side view of the reed switch assembly of the invention in a canal hearing device, with a control magnet in proximity thereto.

FIG. 13 is a side view of the reed switch assembly of the invention in an implanted hearing device, with a control magnet inserted in the ear canal in close proximity to the hearing device.

FIG. 14A is a lateral view illustrating an embodiment of hearing device system having a user interface for remote control of a hearing device positioned in the ear canal.

FIGS. 14B-14D are schematic diagrams illustrating embodiments of a user interface for a hearing device.

FIG. 15 is a state diagram illustrating various operational states of an embodiment of a remotely controlled hearing device.

FIG. 16A-16D are lateral views illustrating use of a magnetic actuator to signal to a remotely controlled hearing device having a user interface.

### DETAILED DESCRIPTION OF THE INVENTION

Embodiments of the present invention provide apparatus, systems and methods for the remote control of various hearing devices such as CIC hearing devices. Various embodiments provide an interface for a user to remotely signal commands to a hearing device positioned within the ear canal. In many embodiments, the hearing device can utilize an ultra miniature switch assembly with unique latching characteristics so as to be remotely activated by a magnet wielded by the wearer of the hearing device. The hearing device can be canal or implanted device type, so a conventional electromechanical or other switch would not be easily accessible by the wearer. In various embodiments, the switch assembly can comprise a miniature reed switch assembly having a pair of reeds within the assembly and a pair of connecting lead wires, and in which a miniature permanent magnet is directly attached either to one of the reeds or to the lead wire associated with the respective reed.

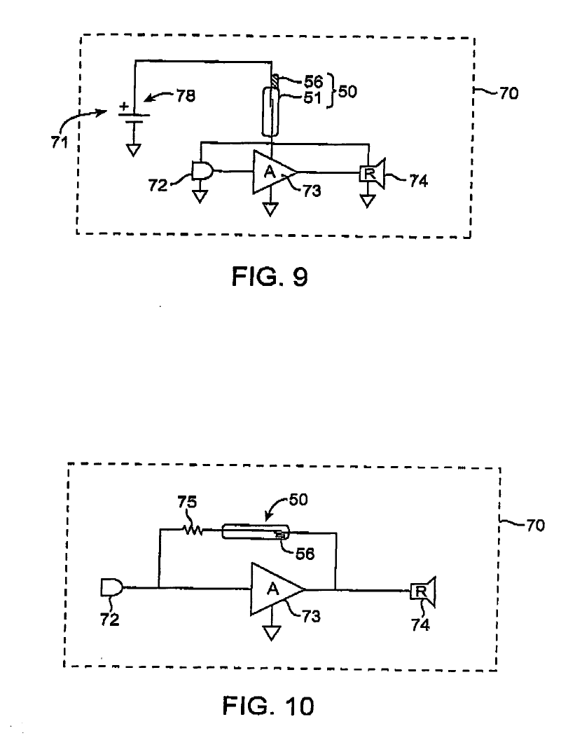

In a preferred embodiment, shown in FIG. 4, the magnetic reed switch assembly 50 is tubular and comprises a hermetically sealing glass casing 51 containing a first reed 52 and a relatively more mobile second reed 53. The reeds are made of flexible ferromagnetic material and thus move in response to a magnetic field. The first and second reeds are attached to connecting lead wires 54 and 55, respectively, which are connected to appropriate points of an electrical circuit. The lead wires are preferably also composed of ferromagnetic material, such as nickel-iron alloy, to enhance the sensitivity and response of the connected reeds to a magnetic field applied proximal to either of the lead wires. In the absence of a magnetic field of sufficient strength, the reeds form an air-gap 57 representing an open contact in the normal position. The normal orientation and mechanical properties of the reeds cause the switch to remain in the “open” position (i.e., an open circuit condition, where the electrical circuit in which the reed switch is connected remains non-conductive as long as that condition exists).

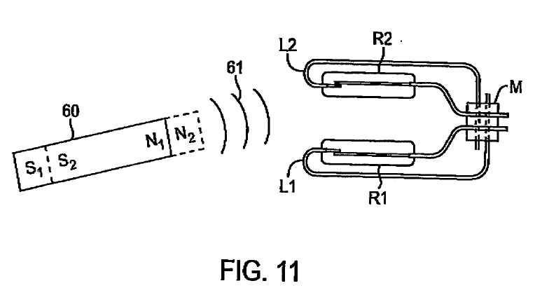

However, when one of the reeds is exposed to a sufficient magnetic field 61 from an external magnet 60 (FIG. 5), the exposed reed becomes magnetized thus attracting the other reed until a closure of the reed contacts occur. This condition represents the “closed” position of the switch (i.e., a closed circuit condition, where the electrical circuit is then conductive) as shown in FIG. 5, in which second reed 53 makes contact with first reed 52 and air-gap 57 (FIG. 4) is eliminated.

Preferably, the miniature latching magnet 56 is mounted directly to the ferromagnetic first lead wire 54. An adhesive 59 is applied at the edge of the magnet-lead junction to hold the magnet to the lead wire 54. The latching magnet 56 produces a magnetic field and, thereby, a force of attraction between reeds 52 and 53. This attraction force alone, however, is intentionally insufficient to close the reed contacts, and hence, the switch remains latched in the “open” position. However, in the presence of a magnetic field 61 produced by a proximate control magnet 60 of appropriate orientation and polarity (60′), the attraction force between the reeds will increase, causing a closure of the contacts and the electrical circuit associated with lead wires 54 and 55. The “closed” condition, shown in FIG. 5, occurs when the control magnet 60 is moved to position 60′ in the direction of arrow 62 and towards second lead wire 55. In the closed position, the air-gap 57 (FIG. 4) between the reeds is eliminated which increases the flux density and the attraction force between the contact reeds. The elimination of the air-gap 57 in the closed position and the magnetic field strength of the latching magnet 56 enables the magnet to maintain closure of the switch even after the removal of the external control magnet 60. Reversing the switch to the normal open position is achieved simply by reversing the polarity of the control magnet 60 and placing it similarly within proximity of second lead wire 55 (condition not shown) to overcome the latching force of the latching magnet 56, whereupon the reed contacts will undergo separation from one another.

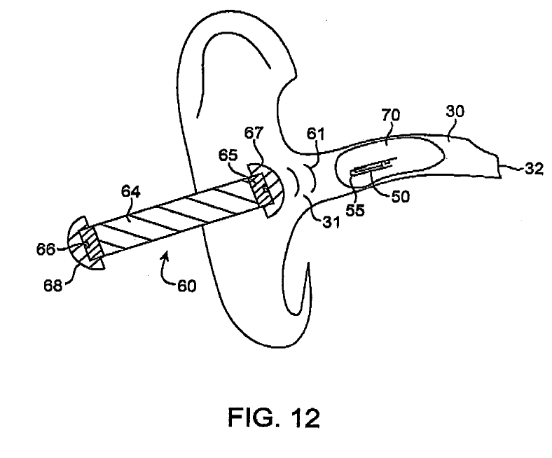

FIG. 6 shows the effect of magnetic flux lines 69 from a control magnet 60 on the reed switch assembly 50. Flux lines within the reed switch assembly (shown by arrow 90) are partially caused by latching magnet 56 and are enhanced to cause closure by flux lines 69 from control magnet 60. The latching magnet 56 is magnetically polarized across (N and S as shown) in order to cause a flux circuit 90 within the reed switch assembly as shown.

The magnet type, size, shape, orientation with respect to the reed switch, and other characteristics are designed such that a latching closure force only occurs upon the substantial reduction of the air-gap 57 between the reeds. Once the reed contacts are opened by an external magnetic force and an air-gap 57 develops in between, the attraction force caused by the latching magnet alone is not sufficient to overcome the mechanical bias force of the reeds towards the open position.

The latching magnet 56 is preferably composed of rare-earth material such as Neodymium Iron Boron (NdFeB) or Samarium Cobalt (SmCo). These magnets are known for their high energy properties, and are typically coated with nickel, gold, aluminum, or other material to prevent corrosion and deterioration of magnetic energy.

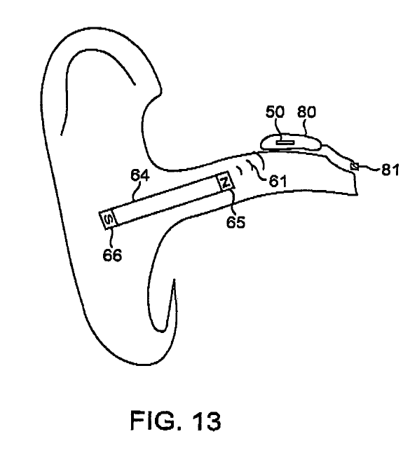

In another embodiment of the invention shown in FIG. 7, the latching magnet 56 is attached to a first reed 52 within casing 51. This configuration provides several advantages including further size reduction of the magnet 56 due to its direct contact with the reed and elimination of coating requirement due to the hermetic sealing effect.

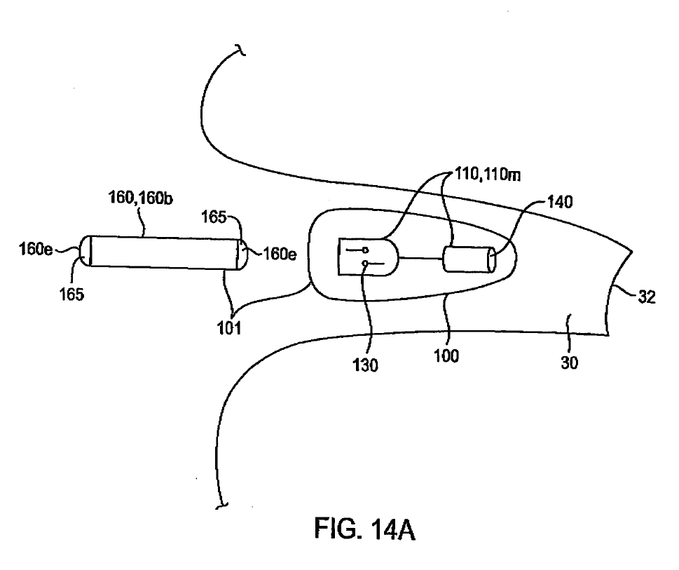

In yet another embodiment, shown in FIG. 8, the latching magnet 56 is wedged in between the two ferromagnetic lead wires with thin layers of adhesive 59 (top and bottom) holding the magnet in place.

Regardless of the configuration or embodiment of the present invention, the spacing between the latching magnet 56 and the underlying ferromagnetic contact must be essentially eliminated in order to achieve the improved efficiency. However, a miniscule spacing, not exceeding approximately 0.2 mm, is permissible since it produces negligible adverse effect on the performance of the switch assembly. This spacing may be caused by a thin layer of magnet coating (not shown) or a layer of adhesive as shown in FIG. 8.

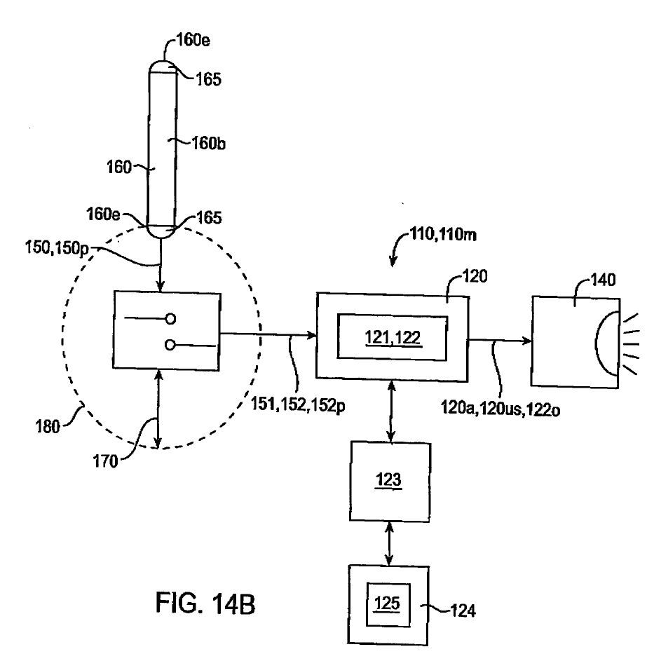

An ideal application of the present invention is in remote power switching (ON/OFF) of inaccessible hearing devices. A simplified schematic of this example application is shown in FIG. 9. The reed switch assembly 50 connects and disconnects power terminal 78 from battery 71 to any active electrical or electroacoustic component such as amplifier 73, microphone 72 or receiver (speaker) 74. Once the switch assembly is remotely turned off, the current drain from the battery is completely shut off and no stand-by current is consumed while the hearing device is in the off position. This energy efficient feature of the present invention is critical for long-term-use applications of canal or implant hearing devices.

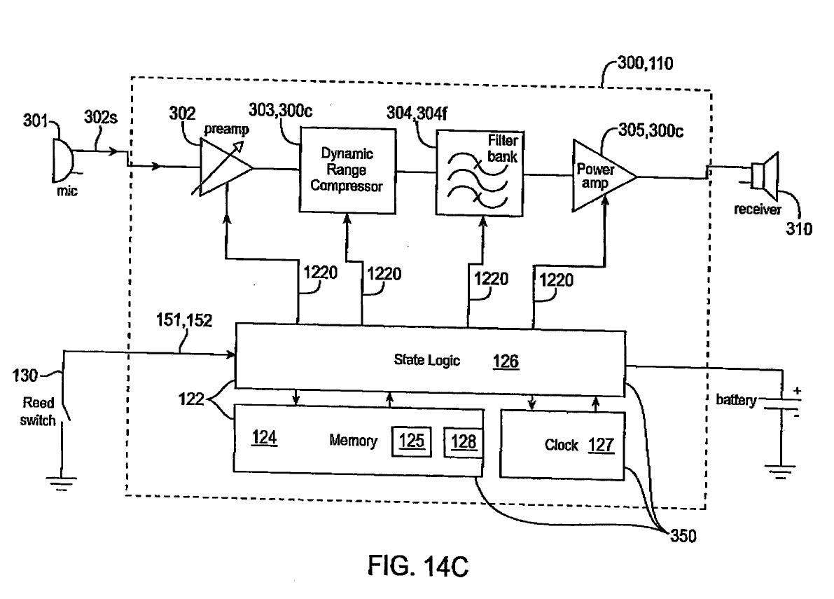

Another application of the present invention is for use in device adjustment such as volume, frequency response or other control or operating parameter. A simplified schematic of an embodiment of a volume control switch, for example, is shown in FIG. 10. The reed switch assembly 50 inserts, on demand by the user, a feedback resistance 75 in the feedback pathway of amplifier 73 (input impedance not shown, for the sake of simplicity). This reduces the amplification, thus altering the volume setting of the hearing device 70. Similar approaches can be used in the adjustment of other parameter such as frequency response.

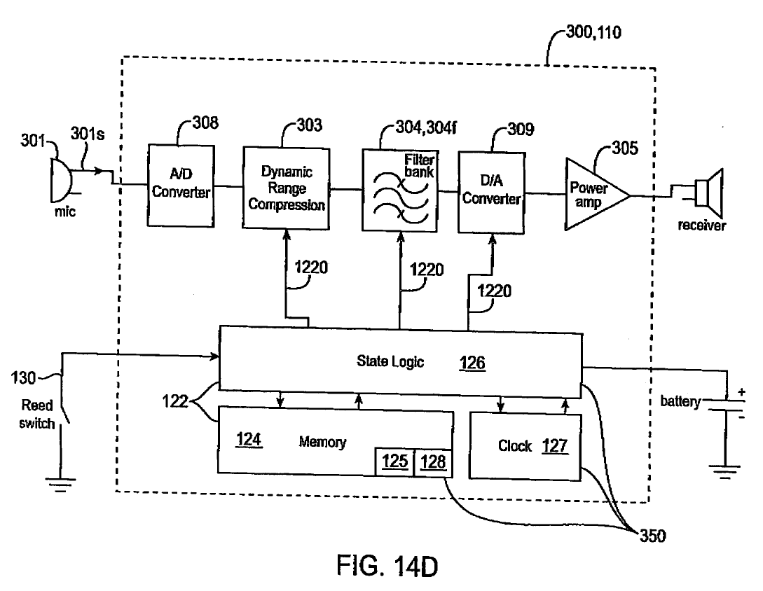

In various embodiments, two or more switches may be combined in the same hearing device to control two or more settings, for example, power and volume settings. FIG. 11 shows an embodiment of a dual switch assembly with a single shared latching magnet M. The reed switches R1 and 112 are configured with lead wires Li and L2 extended to different lengths as shown. Lead wire L1 being closer to the control magnet 60 causes switch R1 to be activated prior to switch 112. This provides a position sensitive control for each of the two settings. For example, when the north pole of the control magnet 62 reaches position N1, R1 switch responds and activates (turns ON) the hearing device. As the control magnet 60 further approaches the dual switch, switch 112 is subsequently activated and an increase in the volume (or change in frequency response, depending on the switch application) occurs. A third or even a fourth switch can be added to control other parameters as well as provide additional fine tuning in the control of given a parameter such as one switch for a course adjustment and another for a fine adjustment.

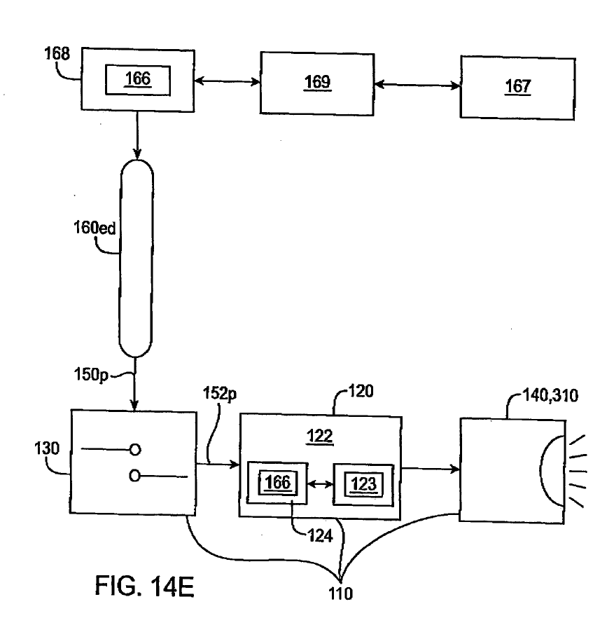

FIG. 12 shows an application of the present invention in a canal hearing device. The hearing device 70 is fully inserted in the ear canal 30 terminating medially by the tympanic membrane 32 (eardrum). The switch assembly 50 is part of a canal hearing device 70 with lead wire 55 laterally positioned facing the magnetic field 61 emanating from a control magnet 60. The bar-shaped control magnet 60 has two magnets 65 and 66 with opposing magnetic polarities (N and S) on each end. Optionally, magnets 65 and 66 can be of the same polarity but have different magnetic strengths. The control magnet may be equally effective with a single bar magnet having opposing poles at each end. Also, stopper flanges, 67 and 68 or other stop means can be optionally placed on each end of the body 64 of control magnet 60 to prevent it from entering the ear canal and possibly touching or pushing the canal device 70.

The control magnet of the present invention preferably incorporates permanent magnets (e.g., magnetic poles of opposite polarity at opposite ends of a bar magnet). However, a magnetic field may be generated by other means known in the art such as by an electromagnet (not shown) comprising a coil, a battery and a switch. The precise magnetic field strength can be adjusted for actuation of a selected switch assembly.

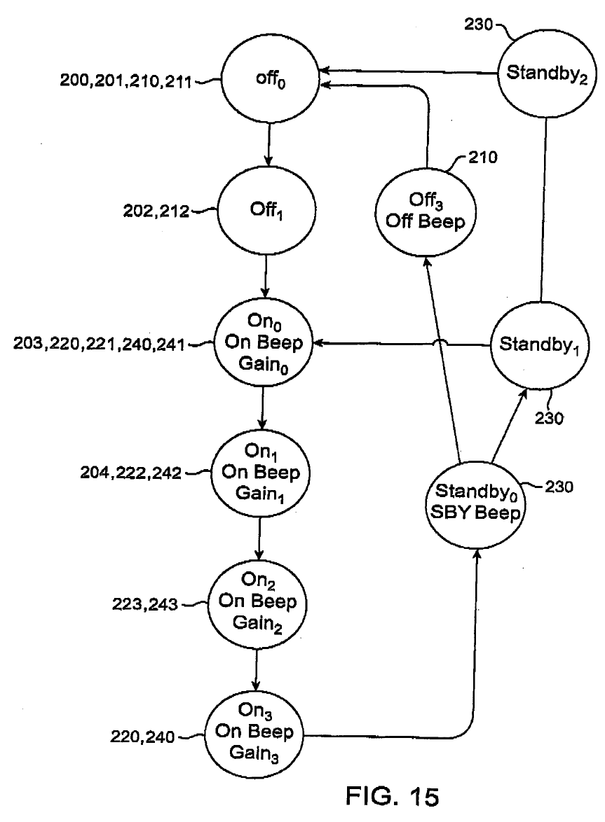

The latching reed switch assembly of the present invention is suitable for any body-worn hearing or audio device that is not readily accessible by the wearer. In implant applications, as shown in FIG. 13 for example, a hearing device 80 is surgically implanted with a vibrating transducer 81 placed on a vibratory structure (not shown) of the middle or inner ear. The implanted hearing device 80 is remotely activated by a control magnet 64 placed in the ear canal by the user.

Two examples of reed switch assemblies fabricated according to the invention will now be described.

### EXAMPLE 1

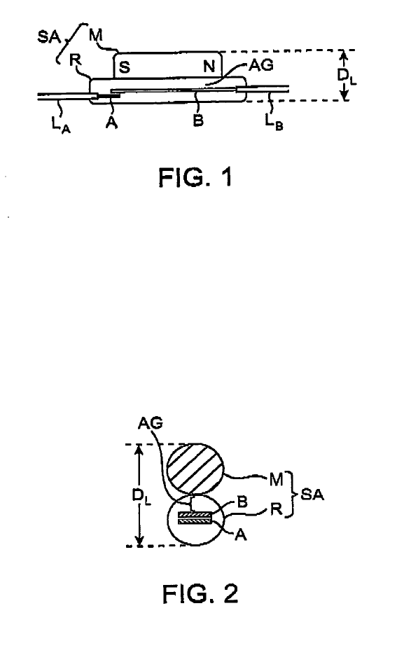

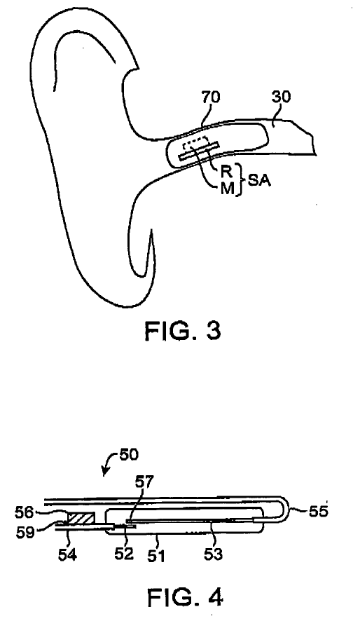

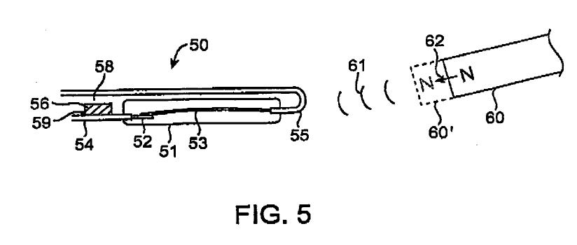

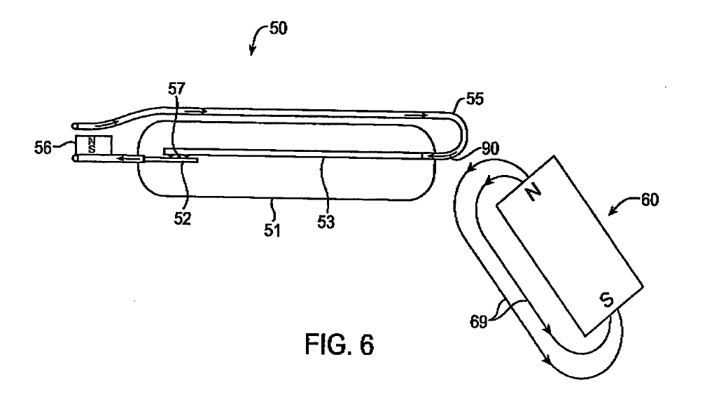

A latching reed switch assembly according to a preferred configuration of the present invention, shown in FIGS. 4-6, was constructed and compared to the prior art switch configuration shown in FIG. 1. The prior art latching reed switch assembly was based on micro-miniature reed switch model HRS-003DT manufactured by Hermetic Switch, Inc. of Chickasha, Okla. The prior art switch assembly included a latching magnet rod (M) constructed of Alnico material and positioned along the length of the tubular reed switch shown in FIG. 1. The magnet M was approximately 4.1 mm long and 1.8 mm in diameter, with a volume of approximately 10.4 mm³. The weight of the magnet was measured to be approximately 74 mg. The reed switch was approximately 5 mm long and 1.25 mm in diameter, with a volume of approximately 6.1 mm³. The reed switch weighed approximately 17 mg with a total of 11 mm of the lead wire attached. The combined volume and weight of the prior art reed switch assembly were approximately 16.5 mm³ and 91 mg, respectively. The cross sectional long diameter (DL, FIG. 2) of the assembly was 3.05 mm.

The embodiment of the present invention shown in FIGS. 4-6 was fabricated using the same reed switch (model HSR-003DT) but with an ultra miniature magnet 56 placed directly on lead wire 54. The magnet, weighing approximately 1.7 mg, was made of Neodymium Iron Boron (NdFeB), a rare-earth magnet which, as noted above, is known for its high magnetic energy (energy product). The miniature magnet was shaped as a thin slab approximately 1 mm L×0.62 mm W and 0.38 mm H with volume of 0.24 mm³ (vs. 10.4 mm³ in prior art designs). The combined volume and weight of the example magnet were approximately 6.3 mm³ and 18.7 mg, respectively. Since the latching magnet 56 is placed on lead wire 54 and its height is only 0.38 mm, the cross sectional diameter of the switch assembly of the present invention is essentially that of the reed switch casing 51. The magnet was aluminum plated to prevent corrosion of the magnetic material. The distant end 57 of the second lead wire 55 was bent and brought close facing the top of magnet 56 and creating an external gap 58 as shown in FIGS. 4 and 6. Minimizing the external gap 58 (FIG. 5) increases the magnetic flux density, thus producing a latching force with even a smaller latching magnet 56.

The correct position of the latching magnet 56 on the lead wire was empirically determined by first placing the latching magnet approximately 5 mm way from edge of the casing 51. The latching magnet 56 was then gradually glided on the lead wire towards the first reed 52 until the reed contacts closed. The latching magnet was then moved away approximately ⅓ mm. This ensured a magnetic attraction between the reeds just below the threshold of closure in the open position. The latching magnet 56 was then attached to the lead wire 54 by a careful application of an adhesive (Loctite 4014). The latching magnet position was approximately 1 mm away from the glass casing 51. The reed switch assembly was then potted with silicone rubber for environmental and handling protection.

A summary comparison between the prior art switch assembly and the switch assembly of the present invention is shown in Table 1 below.

TABLE 1

| | Prior Art Switch | | Present Invention | |
|---|---|---|---|---|
| | (FIG. 1) | | Switch (FIG. 5) | |
| Assembly Volume | 16.5 | mm | 6.3 | mm |
| Assembly Weight | 91 | mg | 18.7 | mg |
| Magnet Weight | 74 | mg | 1.7 | mg |
| Cross Section Long Diameter | 3.05 | mm | 1.25 | mm |

As indicated in Table 1 above, the magnetic switch assembly of the present invention is considerably more efficient than prior art switches in terms of weight, size and configuration for incorporation into a miniature canal hearing device.

### EXAMPLE 2

A control magnet was fabricated to control the latching reed switch assembly described in Example 1 above. The control magnet 60 shown in FIG. 12 was in the shape of a cylindrical rod having a length of 4.3 cm and a diameter of 5.3 mm. The body 64 of the rod was made of plastic and is attached to a pair of identical disk magnets 65 and 66. The two magnets were polarized across the length of the rod and were oriented to have opposing magnetic polarity as shown in FIG. 6. The disk magnets were made of NdFeB material sold by Radio Shack (model No. 64-1895). Each disk magnet was approximately 4.3 mm in diameter and 1.5 mm in height.

The control magnet also had two flanged stoppers (67 and 68), designed to prevent the control magnet from entering the ear canal and accidentally pushing or touching any of the components of the canal hearing device 70. Each stopper was made of polyurethane foam material but, alternatively, may be composed of any other suitable material such as plastic, silicone or silicone rubber.

The function of the control magnet of the above example was tested in conjunction with the latching reed switch assembly described in Example 1. It was found that effective and reliable latching occurred when either end of control magnet (65 or 66) was positioned approximately 15 mm from the switch assembly 50. This distance is considered ideal since it places the control magnet within the vicinity of the canal aperture 31 as shown in FIG. 12.

From the foregoing description, it will be understood that the invention provides a hearing device adapted to be positioned in the ear canal of a user (or alternatively, to be surgically implanted adjacent to the ear canal), which includes electrical circuit means for receiving and processing incoming signals representative of audio signals and converting them to an output for exciting a vibratory structure of the ear of the wearer such as the tympanic membrane, so as to reproduce the processed audio signals therefrom; a magnetically controlled latchable reed switch assembly for controlling at least one of activation and deactivation of the hearing device, or an operating parameter such as volume control or frequency response. The reed switch assembly includes a reed switch including first and second reeds providing electrical contacts spaced apart by an air gap, respective lead wires electrically connected to the first and second reeds and to the electrical circuit means, and a latching magnet directly affixed to either the first reed or to the lead wire associated with the first reed. The latching magnet has a magnetic field of sufficient strength to maintain the first and second reeds together in electrical contact after the air gap is eliminated by an externally applied magnetic field of suitable magnitude, polarity and proximity, but of insufficient strength to bring the first and second reeds together in electrical contact while the air gap exists.

In various embodiments, the latching magnet can be directly affixed to one of the reeds, but in the preferred embodiment each of the lead wires is ferromagnetic and the latching magnet is directly affixed to one of the ferromagnetic lead wires. Alternatively, the latching magnet may be wedged between the ferromagnetic lead wires. The reed switch assembly would typically be a power switch for activation and deactivation of the hearing device, but alternatively or additionally, it may be connected so as to control an operating parameter of the device such as loudness of the output signal that provides the vibratory excitation to enhance the wearer's hearing, or the frequency response of the hearing device.

It should be appreciated that use of latchable reed switch for switch assembly 50 is but one type of magnetically activated switch that be used for switch 50 other types of switches including latchable switches and reed switches known in the art may be equally applicable. For example, miniature hall-effect switches, and MEMS-based magnetic switches can also be used. In various embodiments, the switch assembly can also be configured to be activated by not only by the presence of an external magnetic field but also by a particular magnetic polarity. In still other embodiments the switch can configured to be optically or acoustically activated by the proximity of a handheld actuation device.

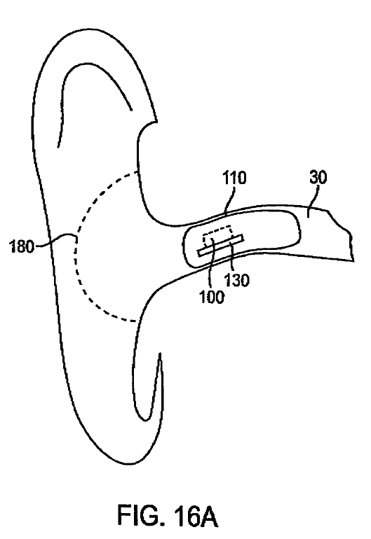

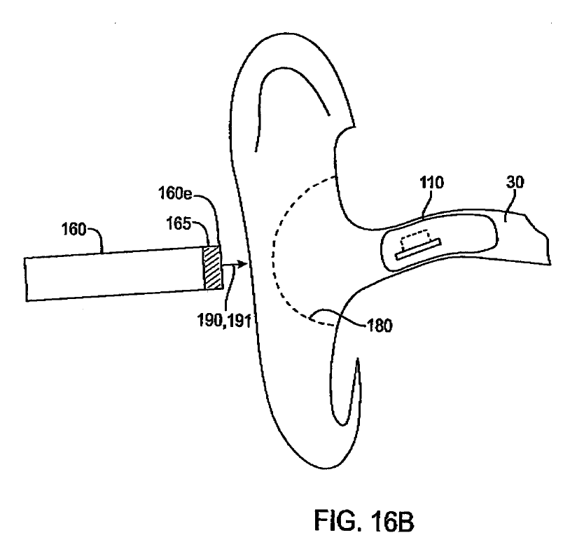

Referring now to FIGS. 14A and 14B an embodiment of an interface 110 for remote control of a hearing device 100 will now be described. The interface 100 will typically comprise a controller 120, a switch 130 and an audio port 140 that are electrically coupled. One or more of these components can be contained within various assemblies of the hearing devices such as a microphone assembly and/or receiver assembly. All or several of the components of the interface can be integrated into a single integrated circuit board or other electronic architecture. Hearing device 100 can include canal devices such as a CIC hearing aid positioned in the bony portion of the ear canal. The hearing device can also have one or more operational states such as an Off-state and On-state which can be remotely selected. Switch 130 is configured to be actuated by a hand-held magnetic field source 160 such as a magnetic bar, magnetic member or other magnet described herein. For ease of discussion, field source 160 will be referred to as actuator 160. In many embodiments, switch 130 is configured to be activated when actuator 160 is at a selected proximity distance 170 (also known as actuation distance) from the switch. When the hearing device is placed in ear canal 10, distance 170 defines a proximity envelope or envelope 180 within which actuator 160 will actuate the switch. In various embodiments, controller 120 is configured to switch between the operational states of the hearing device responsive to a pattern of movement of actuator 160 relative to the proximity envelope as will be explained below.

In embodiments where actuator 160 is a magnetic field source, interface 110 comprises a magnetic user interface and/or an magnetic audio interface in that the user makes using a magnetic field source and received audio outputs. Also as described above, interface 110 can be directly integrated into the hearing device or can be coupled as separate modular assembly 100m configured to be coupled to one or mores components of the hearing device. Collectively, hearing device 100, interface 110 and actuator 160 can comprise a system 101 allowing a user to remotely control a hearing device positioned in the ear canal including a device positioned deep in the ear canal such as the bony portion of the canal.

Switch 130 can include any of the magnetically actuated switches described herein, including without limitation, reed switches, latchable switches, latchable reed switches, hall effect switches, MEMS-based switches, solid state switches and other miniature switches known in the art. In preferred embodiments, switch 130 is a miniature reed switch. In other embodiments, switch 130 can be an optical switch known in the art and can be configured to be activated by light of a selected intensity from an optical actuator such as an LED or a coherent light source. In still other embodiments, switch 130 can be configured to be activated by a variety of switch activation means including by energy sources such as acoustic, RF, infrared and like sources.

Switch 130 can also be integrated with controller 140 or other hearing device component on an integrated circuit board or other electronic architecture. The switch can be configured to have an actuation proximity distance 170 for a given magnetic field strength so to define an proximity envelop 180. The proximity distance/envelope to actuate the switch will typically by bounded by an external portion of the ear canal but can be any selected distance, for example one to five centimeters from the switch. The proximity distance for switch actuation can be fixed or can be programmable either at the factory or by the audiologist or the user. This can be done based on factors such as user preference, user dexterity, user head and ear anatomy, depth and placement of the hearing device and like factors.

The controller 120 is configured to switch between the operational states of the hearing aid responsive to an input 150 from the user which actuates the switch 130. In many embodiments, input 150 comprises a pattern of movement of actuator 160 relative to the proximity envelope 180 of switch 130. Once activated switch, 130 sends an input 151 to the controller 120 which is utilized by the controller to determine whether to change operational states of the hearing device. In various embodiments, controller 120 can comprise a control circuit 121 which can be configured as a state device 122 (also known as a state machine 122) that uses one or more control inputs 152 to change to a new state and/or signal an input to another device to change to a new state. Control inputs 152 can include those from switch 130, other electronic devices (e.g., sensors circuits, etc. not shown) as well as an input 153 from device 122 of its previous/current state. Control circuit 121 can comprise various analog control circuitry known in the art.

In various embodiments, controller 120 and/or state device 122 can comprise a microprocessor 123 and an associated memory 124 (association can be performed by a buss or other association means). Memory 124 and/or microprocessor 123 can include one or more state switch switching modules or programs 125 which are implemented by microprocessor 123. Programs 125 are configured to control one or more aspects of the state switching process including what inputs will cause a switching of states (e.g., signals from switch 160 including duration of those signals), which state will be switched to, the sequence of switching etc. In specific embodiments, programs 125 are configured to recognize user inputs 150 that comprise a pattern of movement of actuator 160 including patterns of movement of the actuator relative to the proximity envelope 180. As will explained below, these patterns result in a series of signals 151 from switch 130 to controller 120.

Audio port 140 is configured to output an audio signal 120a from controller 120 (or other signal generating means) indicating to a change in the operational state of the hearing device and/or the selection of particular state as is described below. Audio port 140 will typically comprise a part of the hearing device such as the audio port of a hearing aid receiver assembly but can also comprise a separate port coupled to the hearing device.

In various embodiments, the actuator is a magnetic field source 160 that is configured to be held in the hand of the user such as a magnetic rod, bar or other magnetic member or hand held magnetic device (e.g., and electromagnet). Actuator 160 can include one or more embodiments of control magnet 60 described herein. The actuator can include a body portion 160b and end portions 160e. All of the actuator can be magnetic (e.g., a magnetic rod) or can have one or more magnets 165 positioned at end portions 160e. The actuator has a length, shape (e.g., rod shaped) and magnetic field strength to allow the user to move the actuator in a pattern of movement relative to the proximity envelope 180 of switch 130 as is described herein. The magnetic field strength of the actuator can be selected to define a selected proximity distance 170 for switch 130. In various embodiments, actuator 160 can be incorporated into a key chain (not shown) to allow the actuator to be easily carried by the user. The actuator can also be incorporated into hearing device removal and/or insertion tool (not shown) to allow the user to perform multiple hearing aid related operations with a single device. Various examples of a hearing aid removal tool are described in U.S. patent application Ser. No. 11/0531,074 which is fully incorporated by reference herein.

In alternative embodiments, actuator 160 can include an energy source (not shown) such as an optical, infrared, acoustic or RF energy source. In one embodiment actuator 160 can include an LED configured to actuate an optical switch at a selected distance 170.

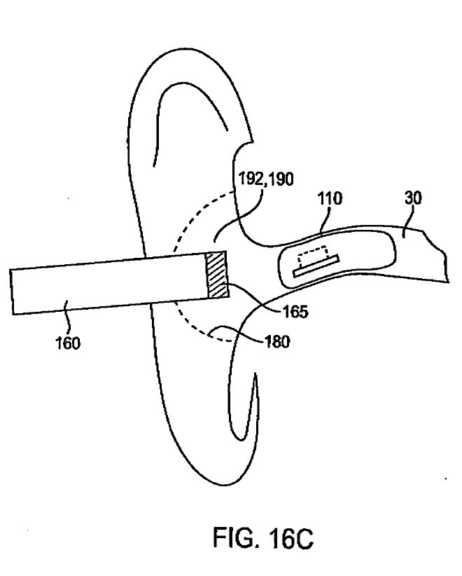

Referring now to FIG. 15, in various embodiments hearing device 100 can have one or more operational states 200 such as an on-state, off-state, etc. The selection and implementation of a particular state 200 can be achieved through the use of controller 120 as described herein. Further as described herein, the user can select and switch between the states using interface 100 together with a hand held actuator 160. The user can select a particular state 200 by signaling an input 150 to interface 100 through the use of a pattern of movement 190 of the actuator. Select patterns 190 correspond to particular states 200 or commands to switch between states.

Typically, device 100 can include at least a first state 201 and a second state 202. In many embodiments, the device will also include a third and fourth state 203 and 204 and additional states as needed. States 200 can include an off-state 210 and on-state 220, a standby state 230 and other like states. Off-states 210 can include at least a first and a second off-state 211 and 212. Similarly, on-states 220 can include a first and second on-state 221 and 222 and standby states 223 a first and second standby state 231 and 232. On-states 220 can include states where the device has different gains 240 (or other hearing aid parameter such as volume) such as a first gain 241 associated with a first on-state 221, a second gain associated with second on-state 222 and a third gain associated with a third on-state 223. By switching between the on-states, the user can increase or decrease the gain (or other hearing aid parameter) as desired.

Standby states 230 can include states where the hearing device operates in a power saving mode, e.g., with no or minimum gain. In one embodiment standby states 230 can include a ship state where the hearing device is configured to use minimal power during ship and storage. In the ship state, the hearing device requires a specific sequence of control inputs 152 to be turned into an on-state. The control inputs can comprise a discrete rapid sequence of pulses, or pulse train 152p, generated for example by an electromagnet which is configured to generate a series of magnetic pulses 150p as inputs 150 which in turn results in a series of pulsed signals 151 from switch 130. Use of a pulse train or other discrete sequence of control inputs 152 during the ship mode prevents accidental activation of the hearing device during shipping and storage, for example from a stray magnetic field. Similarly, it can also prevent accidental entry into the shipping mode. Other states 200 can also be configured to require a pulsed input or other discrete signal 152p in order to be entered to and exited from. The ship mode can also be configured as an off-state, which also requires a rapid sequence of inputs to entered and existed from. In another embodiment, a standby state 230 can include an acoustical transparent or sleep mode where the device provides a reduced gain configured to simulate the acoustical perception to the user when the device is not in the ear. Further description of a sleep mode of operation is found in U.S. patent application Ser. No. 11/173,816 which is fully incorporated by reference herein.

In various embodiments, controller 120 (or other signal generating means) can be configured to generate an audio signal 120a (e.g., one or more beeps) indicating to the user that the device has switched states and/or which state the device has been switched to. This signal is outputted to the audio port 140. Signals 120a can correspond to beeps (or other sounds) of various duration, pitch and volume. They can also correspond to a series of beeps or multiple-tone beeps such as a two-tone beep. Each state can have an identifying audio signal or 120 as so as to alert the user when a particular state has been selected. Controller 120 can also be configured generate other types of output signals to alert the user of change in state of the hearing device. Such other output signals can include optical signals, vibratory as well as an RF signal which is signaled to a remote speaker, display device, or other output device.

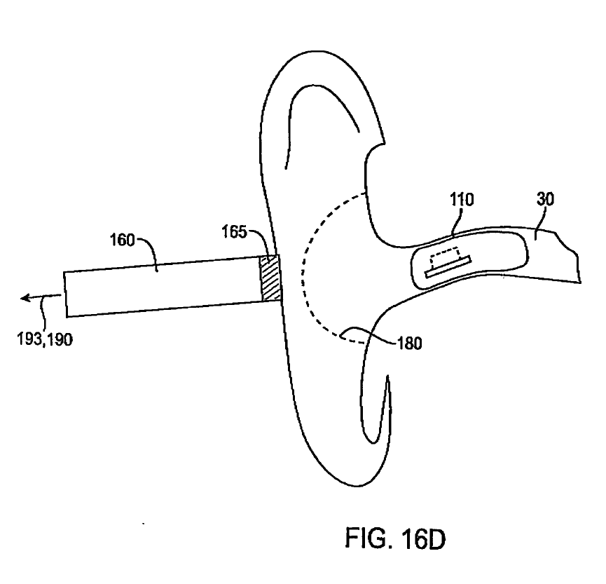

Referring now to FIGS. 16-16D, in various embodiments a user input 150 to change the operational state 200 of the hearing aid can comprise patterns of movement of actuator 160 including patterns of movement 190 of the actuator relative to the proximity envelope 180 of switch 130. These patterns can correspond to a signal to switch to a particular state 200 or to switch between states (e.g., to switch to a previous or following state). Each pattern 190 actuates and/or de-actuates switch 130 in such a manner so as to generate a signal 151 or series of signals 151 to controller 120. Controller then utilizes signal(s) 151 to determine whether to change states and/or which state to change to. The particulars pattern 190 can include a pattern 191 of moving actuator 160 (i.e., in this case the magnetic field source e.g., magnet 165) into the proximity envelope (see FIG. 16B), a pattern 192 of maintaining the actuator in the proximity envelope (see FIG. 16C), or a pattern 193 of removing the actuator from the proximity envelope(see FIG. 16C). Combinations of these patterns can in turn, comprise other patterns. For example, two or more of the above patterns can be made in succession, such as moving the magnet into the proximity envelope and then moving the magnet out of the proximity envelope. Also the pattern of maintaining the magnet in the proximity envelope can comprise multiple patterns depending on the duration of the magnet in the proximity envelope. For example, a duration of 1-3 seconds can comprise a first pattern, a duration of 5-20 seconds a second pattern, a duration of 20 to 30 seconds a third pattern and so on. The patterns can be preset at the factory or can be selectable by the user. The user can also program in custom patterns, for example using the switching module. The user can also program a pattern based on the duration of the magnet in a particular location, e.g. within the proximity envelope.

In an embodiment of method for using interface 100 to switch between operation states of s hearing device 100 the user, once the device is positioned in the ear the user can use actuator 160 to make a first signal 190 to turn the device from an off-state 210 to an on-a first state 221. The interface then generates an audio signal 120a or on-beep indicating that the hearing device has been switched on. The user can then make further signals 190 with the actuator to switch between the on-states to for example change the gain or other hearing aid parameter. With each switch to a new state the interface generates a beep or other audio-signal to alter the user that a state switch has occurred. The user can also make signals 190 to switch the hearing device to one or more standby states 230 or back to an off state 210 again receiving an audio-signal indicating such. In this way of inputting signals 190 and receiving audio outputs 120a the user is able to remotely select the operational state of the hearing device and thus control the hearing device when the device is positioned anywhere in the ear canal including deep in the canal in the bony portion. Further these and related embodiments of using interface 110, allow the user to control their device without having to remove it from their ear canal

### CONCLUSION

The foregoing description of various embodiments of the invention has been presented for purposes of illustration and description. It is not intended to limit the invention to the precise forms disclosed. Many modifications, variations and refinements will be apparent to practitioners skilled in the art. Further, the teachings of the invention have broad application in the hearing aid device field as well as other fields which will be recognized by practitioners skilled in the art. For example, methods of the invention using patterns of movement of a handheld magnetic field source or other actuation means can applied for the remote activation of an implanted medical device (e.g., a pacemaker or insulin pump) or other user inaccessible medical device or even a portable electronic device such as a pda, cell phone, mp3 player and like device.

Elements, characteristics, or acts from one embodiment can be readily recombined or substituted with one or more elements, characteristics or acts from other embodiments to form numerous additional embodiments within the scope of the invention. Moreover, elements that are shown or described as being combined with other elements, can in various embodiments, exist as stand alone elements. Hence, the scope of the present invention is not limited to the specifics of the exemplary embodiment, but is instead limited solely by the appended claims.

What is claimed is:

1. A method for remotely controlling the operational state of a hearing aid positioned in the ear canal, the method comprising:
positioning a hearing aid deep in the ear canal of a user, wherein the hearing aid has at least a first state and a second state, a magnetically activated switch, and a controller for controlling switching between the states;
signalling a user input to change the state of the hearing aid through a pattern of movement of a hand held magnetic field source made relative to a proximity distance to the switch sufficient to produce a field strength to activate the switch; and
utilizing the controller to switch between the first state and the second state responsive to the pattern of movement.

2. The method of claim 1, wherein the user input comprises a movement pattern to change the hearing aid to an on-state, a standby-state or to change a hearing-aid parameter.

3. The method of claim 2, wherein the parameter is a hearing aid gain.

4. The method of claim 1, wherein the pattern of movement comprises moving the magnetic field source into proximity to the switch, moving the magnetic field source out of proximity, or maintaining the magnetic field source at proximity.

5. The method of claim 4, wherein the pattern of movement comprises making two or more individual patterns of movement in succession.

6. The method of claim 1, wherein the pattern of movement comprises maintaining the magnetic field source at proximity to the switch for a selected duration.

7. The method of claim 6, wherein the duration includes at least a first duration and a second duration.

8. The method of claim 1, wherein the movement pattern is selectable by the user.

9. The method of claim 1, wherein the switch is a miniature reed switch.

10. The method of claim 1, wherein the switch is configured to be activated by bringing the magnetic field source into an external portion of the ear canal.

11. The method of claim 1, further comprising:
generating an audio output indicating that the hearing aid has switched to the second state.

12. The method of claim 1, wherein the controller comprises at least one of a state device or a processor.

13. The method of claim 12, wherein the processor comprises a memory and a clock.

14. The method of claim 12, wherein the processor comprises a state switching module.

15. The method of claim 1, wherein the first state is an off-state and the second state is an on-state.

16. The method of claim 1, further comprising:
switching between the second state and a third state responsive to the pattern of movement.

17. The method of claim 16, further comprising:
generating an audio output indicating that the hearing aid has switched to the third state.

18. The method of claim 16, wherein the first state is an off-state, the second state is an on-state, and the third state is a standby-state.

19. The method of claim 16, wherein the first state is an off-state, the second state is an on-state, and the third state is an off-state.

20. The method of claim 16, wherein the first state is an off-state, the second state is a first on-state, and the third state is a second on-state.

21. The method of claim 20, wherein the first on-state has a first gain; and the second on-state has a second gain.

22. The method of claim 21, further comprising:
generating an audio output indicating that the gain of the hearing aid has been changed.

23. The method of claim 21, wherein the second gain is larger than the first gain.

24. A method for remotely controlling the operational state of a hearing aid positioned in the ear canal, the method comprising:
positioning a hearing aid deep in the ear canal of a user, wherein the hearing aid has at least a first state and a second state, a magnetically activated switch; and a controller for controlling state switching;
signalling a user input to change the state of the hearing aid by positioning a magnetic field source relative to a proximity to the switch sufficient to generate a field strength to activate the switch; and
utilizing the controller to switch between the first state and the second state responsive to the user input.

25. A user interface for remotely controlling the operational state of a hearing aid positioned in the ear canal of a user, the interface comprising:
a controller for switching between the operational states of a hearing aid having at least a first and a second operational state;
a switch coupled to the controller for receiving inputs from the user to change the operational state of the hearing aid, the switch actuable by an external magnetic field source held in the hand of the user within a selected proximity envelope from the switch; and
an audio port coupled to the controller for producing audio outputs indicating to the user the operational state of the hearing aid; and
wherein the controller is configured to switch between the states responsive to a user pattern of movement of the magnetic field source made relative to the proximity envelope.

26. The interface of claim 25, wherein the proximity envelope is bounded by an external portion of the ear canal.

27. The interface of claim 25, wherein the switch is a miniature reed switch.

28. The interface of claim 25, wherein the pattern of movement comprises moving the magnetic field source into the proximity envelope, moving the magnetic field source out of the proximity envelope, or maintaining the magnetic field source in the proximity envelope.

29. The interface of claim 25, wherein the controller is configured to generate an audio signal for the audio port indicating the hearing aid has switched states.

30. The interface of claim 25, wherein the first state is an off-state and the second state is an on-state.

31. The interface of claim 25, wherein the hearing aid includes a third state.

32. The interface of claim 31, wherein the first state is an off-state and the second state is an on-state having a first gain and the third state is an on-state having a second gain.

33. The interface of claim 25, wherein the controller generates an audio output signal indicating that the hearing aid has switched to a particular state.

34. The interface of claim 25, wherein the controller comprises at least one of a state device or a processor.

35. The interface of claim 34, wherein the processor comprises a state switching module.

36. The interface of claim 34, wherein the processor comprises a memory and a clock.

37. The interface of claim 25, wherein the audio port is part of a hearing aid receiver assembly configured to supply acoustic signals received from a hearing aid microphone assembly to a tympanic membrane of the user.

38. An interface for remotely controlling the operational state of a hearing aid positioned deep in the ear canal of a user, the interface comprising:
a controller for switching between the operational states of a hearing aid having at least a first and a second operational state;
a switch coupled to the controller, the switch actuable by an external magnetic field source held in the hand of the user; and
an audio port coupled to the controller for producing audio outputs indicating to the user the operational state of the hearing aid, and
wherein the controller is configured to switch between the states responsive to a duration of an actuation signal from the switch, the controller also configured to generate an audio signal indicating the hearing aid has switched states.

39. A user interface for remotely controlling the operational state of a hearing aid positioned in the ear canal of a user, the interface comprising:
a controller for switching between the operational states of a hearing aid having at least a first and a second operational state;
a switch coupled to the controller for receiving inputs from the user to change the operational state of the hearing aid, the switch actuable by an external energy source held in the hand of the user within a selected proximity envelope from the switch; and
an audio port coupled to the controller for producing audio outputs indicating to the user the operational state of the hearing aid; and
wherein the controller is configured to switch between the states responsive to a user pattern of movement of the external energy source made relative to the proximity envelope.

40. The interface of claim 39, wherein the external energy source is one of an optical, magnetic or acoustic energy source.

41. A user interface for remotely controlling the operational state of a hearing aid positioned in the ear canal of a user, the interface comprising:
a controller for switching between the operational states of a hearing aid having at least a first and a second operational state;
a switch coupled to the controller for receiving inputs from the user to change the operational state of the hearing aid, the switch actuable by an external magnetic field source held in the hand of the user within a selected proximity envelope from the switch; and
an output device coupled to the controller for producing outputs indicating to the user the operational state of the hearing aid; and
wherein the controller is configured to switch between the states responsive to a user pattern of movement of the magnetic field source made relative to the proximity envelope.

42. A system for remotely controlling the operational state of a hearing aid positioned deep in the ear canal of a user, the system comprising:
a hearing aid having at least a first and a second operational state, the hearing aid comprising a controller for switching between the operational states, a magnetically actuated switch coupled to the controller, an audio port coupled to the controller for producing audio outputs indicative of the operational state of the hearing aid; wherein the controller is configured to switch between the states responsive to a user pattern of movement of a hand held magnetic field source made relative to a proximity envelope from the switch sufficient to produce a field strength to activate the switch, the controller also configured to generate an audio signal indicating the hearing aid has switched states; and
a hand held magnetic field source for actuating the switch and making user inputs to the controller to change the operational state of the hearing aid.

43. The system of claim 42, wherein the pattern of movement comprises moving the magnetic field source into the proximity envelope, moving the magnetic field source out of the proximity envelope, or maintaining the magnetic field source in the proximity envelope.
